(19) United States
(12) Patent Application Publication
(10) Pub. No.: US 2025/0350380 A1
(43) Pub. Date: Nov. 13, 2025

(54) RADIO WAVE PROPAGATION PROPERTY CALCULATION DEVICE AND RADIO WAVE PROPAGATION PROPERTY CALCULATION METHOD

(71) Applicant: Mitsubishi Electric Corporation, Tokyo (JP)

(72) Inventor: Kenya SHIMIZU, Tokyo (JP)

(73) Assignee: Mitsubishi Electric Corporation, Tokyo (JP)

(21) Appl. No.: 19/275,611

(22) Filed: Jul. 21, 2025

Related U.S. Application Data
(63) Continuation of application No. PCT/JP2023/003300, filed on Feb. 2, 2023.

(51) Int. Cl. H04B 17/309; H04B 17/391

(52) U.S. Cl. CPC H04B 17/309; H04B 17/3913

(57) ABSTRACT

A radio wave propagation property calculation device includes processing circuitry to calculate, using a predetermined propagation estimation formula, a first estimation value of electric power received at a first evaluation point, and a second estimation value of electric power received at a first reference point, to calculate a first feature amount being related to a first area including the first evaluation point, a second feature amount being related to a second area including the first reference point, a third feature amount being related to a third area including a first measurement point, and a fourth feature amount being related to a area including a second measurement, and to calculate a relative value of the first and second estimation values, actually measure and correct the first estimation value based on the first to fourth feature amounts and the calculated relative value, and calculate a correction value of the first estimation value.

### CROSS REFERENCE TO RELATED APPLICATION

This application is a Continuation of PCT International Application No. PCT/JP2023/003300, filed on Feb. 2, 2023, which is hereby expressly incorporated by reference into the present application.

### TECHNICAL FIELD

The present disclosure relates to a radio wave propagation property calculation technique.

### BACKGROUND ART

A radio wave propagation property can be estimated using an estimation method that uses numerical analysis based on the electromagnetic field theory or an estimation method that uses an empirical mathematical formula. Both of the estimation methods, however, cause an estimation error. There is known a method of correcting an estimation value using measurement data to reduce an estimation error. By correcting the estimation value using the measurement data, it is possible to obtain a more accurate estimation value.

Patent Literature 1 discloses a technique related to a radio wave propagation property estimation system that actually measures and corrects, at any evaluation point in an evaluation area for estimating the radio wave propagation property, a reception level estimation value of a radio wave transmitted from a transmission point at which a transmission station is located using a reception level actual measurement value measured at a measurement point, and that includes a propagation estimation unit that calculates the reception level estimation value at the evaluation point using a predetermined propagation estimation equation, an actual measurement/correction unit that actually measures and corrects the reception level estimation value on the basis of the degree of reliability indicating a relationship between propagation loss the radio wave of which has been transmitted from the transmission point and that is obtained at the evaluation point and propagation loss of the radio wave at the measurement point, and an angle-specific reliability degree calculation unit that calculates the degree of reliability on the basis of an angle formed by a line segment connecting the transmission point and the evaluation point, and a line segment connecting the transmission point and the measurement point. As illustrated in FIG. 1 of Patent Literature 1, this measurement point needs to be located in the evaluation area in which the evaluation point is located.

### CITATION LIST

### Patent Literature

Patent Literature 1: JP 2012-100153 A

### SUMMARY OF INVENTION

### Technical Problem

A correction method according to Patent Literature 1 has a problem that, when there is no measurement point in the evaluation area in which an evaluation point is located, the degree of reliability cannot be calculated, and correction cannot be performed.

The present disclosure has been made to solve such a problem, and an object of the present disclosure is to provide a radio wave propagation property calculation technique that, when there is no measurement point in an evaluation area in which an evaluation point is located, can correct the radio wave propagation property of the evaluation point.

### Solution to Problem

A radio wave propagation property calculation device according to one aspect of an embodiment of the present disclosure includes processing circuitry to calculate, using a predetermined propagation estimation formula, a first estimation value of received electric power of a radio wave and a second estimation value of received electric power of the radio wave, the radio wave being transmitted from a first transmission point, the received electric power of the first estimation value being received at a first evaluation point located in an evaluation area including the first transmission point, and the received electric power of the second estimation value being received at a first reference point located in the evaluation area, to calculate a first feature amount, a second feature amount, a third feature amount and a fourth feature amount, the first feature amount being related to a first feature amount calculation area including the first evaluation point, the second feature amount being related to a second feature amount calculation area including the first reference point, the third feature amount being related to a third feature amount calculation area including a first measurement point located in a measurement area that is an area different from the evaluation area and includes a second transmission point, and the fourth feature amount being related to a fourth feature amount calculation area including a second measurement point located in the measurement area, and to perform calculation of a relative value of the first estimation value and the second estimation value, and a correction value of the first estimation value by performing actual-measurement-based correction of the first estimation value on a basis of the first to fourth feature amounts and the calculated relative value.

### Advantageous Effects of Invention

When there is no measurement point in an evaluation area in which an evaluation point is located, the radio wave propagation property calculation device according to the embodiment of the present disclosure can correct the radio wave propagation property of the evaluation point.

### BRIEF DESCRIPTION OF DRAWINGS

FIG. 1 is an explanatory view of an evaluation area 10 and a measurement area 20 according to Embodiment 1 of the present disclosure.

FIG. 2 is a block diagram illustrating a configuration example of a radio wave propagation property calculation device 100 according to Embodiment 1 of the present disclosure.

FIG. 3A is a diagram illustrating a hardware configuration example of the radio wave propagation property calculation device 100 according to Embodiment 1 of the present disclosure.

FIG. 3B is a diagram illustrating a hardware configuration example of the radio wave propagation property calculation device 100 according to Embodiment 1 of the present disclosure.

FIG. 4 is a flowchart illustrating an operation example of the radio wave propagation property calculation device 100 according to Embodiment 1 of the present disclosure.

FIG. 5 is a flowchart illustrating an operation example of a feature amount calculation unit 120 according to Embodiment 1 of the present disclosure.

FIG. 6 is a flowchart illustrating an operation example of an actual measurement/correction unit 130 according to Embodiment 1 of the present disclosure.

FIG. 7 is a block diagram illustrating a configuration example of a radio wave propagation property calculation device 200 according to Embodiment 2 of the present disclosure.

FIG. 8 is a flowchart illustrating an operation example of the radio wave propagation property calculation device 200 according to Embodiment 2 of the present disclosure.

FIG. 9 is a flowchart illustrating an operation example of a reliability degree calculation unit 210 according to Embodiment 2 of the present disclosure.

FIG. 10 is a flowchart illustrating an operation example of a reference point determination unit 220 according to Embodiment 2 of the present disclosure.

FIG. 11 is an explanatory view of an evaluation area 10 and a measurement area 20 according to Embodiment 3 of the present disclosure.

FIG. 12 is a flowchart illustrating an operation example of an actual measurement/correction unit 130 according to Embodiment 3 of the present disclosure.

FIG. 13 is a block diagram illustrating a configuration example of a radio wave propagation property calculation device 400 according to Embodiment 4 of the present disclosure.

FIG. 14 is a flowchart illustrating an operation example of the radio wave propagation property calculation device 400 according to Embodiment 4 of the present disclosure.

FIG. 15 is a flowchart illustrating an operation example of a feature amount calculation unit 420 according to Embodiment 4 of the present disclosure.

FIG. 16 is a block diagram illustrating a configuration example of a radio wave propagation property calculation device 500 according to Embodiment 5 of the present disclosure.

FIG. 17 is a flowchart illustrating an operation example of a feature amount calculation unit 520 according to Embodiment 5 of the present disclosure.

FIG. 18 is a flowchart illustrating an operation example of an actual measurement/correction unit 530 according to Embodiment 5 of the present disclosure.

### DESCRIPTION OF EMBODIMENTS

Various embodiments of the present disclosure will be described in detail below with reference to the accompanying drawings. Note that components assigned the identical or similar reference numerals in the drawings will have identical or similar components or functions, and redundant description of these components will be omitted.

### Embodiment 1

### <Explanation of Evaluation Area 10 and Measurement Area 20>

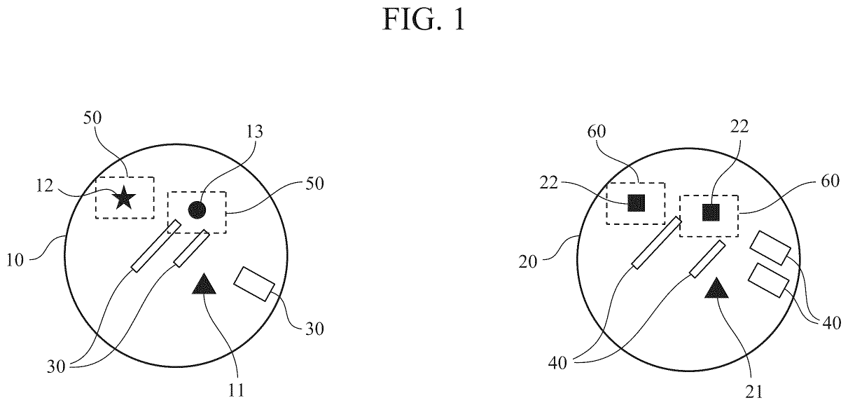

An evaluation area and a measurement area according to the present embodiment will be described with reference to FIG. 1. FIG. 1 is an explanatory view of an evaluation area 10 and a measurement area 20. In FIG. 1, 10 denotes an evaluation area, 11 denotes a transmission point in the evaluation area, 12 denotes an evaluation point, 13 denotes a reference point, 20 denotes a measurement area, 21 denotes a transmission point in the measurement area, 22 denotes a measurement point, 30 denotes a shielding object for a radio wave in the evaluation area, 40 denotes a shielding object for the radio wave in a measurement area, 50 denotes feature amount calculation areas that surround each of the evaluation point and the reference point in the evaluation area, and 60 denotes feature amount calculation areas that surround each of measurement points in the measurement area.

The transmission point 11 is a spot at which a transmission station that transmits a radio wave is located. The evaluation point 12 is a spot at which a propagation property related to the radio wave transmitted from the transmission point 11 is evaluated and that is a correction target point. The reference point 13 is a spot at which the propagation property related to the radio wave transmitted from the transmission point 11 is evaluated and that is not a correction target point. The propagation property at the reference point 13 is a reference for correcting the propagation property at the evaluation point 12. In a case where a term “target point” is used or a case where an “evaluation point” is simply described in the present disclosure, the term “target point” or “evaluation point” includes the evaluation point 12 and the reference point 13. Furthermore, in a case where a term “point of interest” is used in the present disclosure, the term “point of interest” includes a target point, an evaluation point, or a measurement point. The evaluation area 10 is an area that is set to surround all of the transmission point 11, the evaluation point 12, and the reference point 13. The shielding object 30 is an object that is located in the evaluation area 10 and shields the radio wave from the transmission point 11. The shielding object 30 is more specifically a building or topography. The feature amount calculation areas 50 are areas that are set to surround each of the evaluation point 12 and the reference point 13. That is, the one feature amount calculation area 50 is set to surround the evaluation point 12, and the other feature amount calculation area 50 is set to surround the reference point 13.

The transmission point 21 is a spot at which the transmission station that transmits the radio wave is located. The measurement point 22 is a spot at which a propagation property related to the radio wave transmitted from the transmission point 21 is measured. FIG. 1 illustrates the two measurement points 22. The measurement area 20 is an area that is set to surround all of the transmission point 21 and the measurement points 22. The shielding object 40 is an object that is located in the measurement area 20 and shields the radio wave from the transmission point 21. The shielding object 40 is more specifically a building or topography. The feature amount calculation areas 60 are areas that are set to surround the respective measurement points 22. That is, the one feature amount calculation area 60 is set to surround the one measurement point 22, and the other feature amount calculation area 60 is set to surround the other measurement point 22.

The evaluation area 10 and the measurement area 20 are illustrated as circular shapes in FIG. 1, yet may have shapes other than the circular shapes. Furthermore, although only the one measurement area 20 is illustrated in FIG. 1, there may be a plurality of the measurement areas 20. Furthermore, the feature amount calculation areas 50 and 60 are illustrated as rectangular shapes, yet may have shapes other than the rectangular shapes. Furthermore, specific examples of the propagation property include received electric power, propagation loss, a delay time property, an arrival angle property, and a frequency property. Furthermore, the one feature amount calculation area 50 may include a plurality of the evaluation points 12 or reference points 13, and the one feature amount calculation area 60 may include a plurality of the measurement points 22.

### <Configuration of Radio Wave Propagation Property Calculation Device 100>

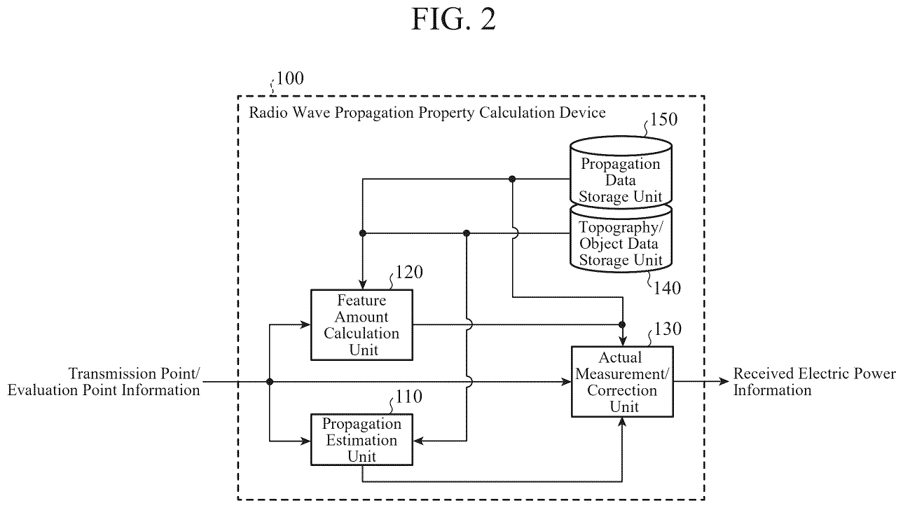

A configuration example of a radio wave propagation property calculation device 100 according to the present embodiment will be described with reference FIG. 2. FIG. 2 is a block diagram illustrating the configuration example of the radio wave propagation property calculation device 100 according to the present embodiment.

The radio wave propagation property calculation device 100 receives input of information (hereinafter, referred to as “transmission point/evaluation point information”) related to a transmission point and an evaluation point, and outputs received electric power information obtained at the evaluation point 12. The “transmission point” includes the transmission point 11 and the transmission point 21. As described above, the “evaluation point” includes the evaluation point 12 and the reference point 13.

As illustrated in FIG. 2, the radio wave propagation property calculation device 100 according to one aspect includes a propagation estimation unit 110, a feature amount calculation unit 120, an actual measurement/correction unit 130, a topography/object data storage unit 140, and a propagation data storage unit 150 as components or function units. The topography/object data storage unit 140 and the propagation data storage unit 150 may be provided outside the radio wave propagation property calculation device 100.

Furthermore, the radio wave propagation property calculation device 100 according to one aspect includes: the propagation estimation unit 110 that calculates using a predetermined propagation estimation formula a first estimation value of received electric power the radio wave of which is transmitted from the first transmission point 11 and that is received at the first evaluation point 12 located in the evaluation area 10 including the first transmission point, and a second estimation value of received electric power that is received at the first reference point 13 located in the evaluation area; the feature amount calculation unit 120 that calculates a first feature amount related to the first feature amount calculation area 50 including the first evaluation point 12 and a second feature amount related to the second feature amount calculation area 50 including the first reference point 13, and a third feature amount related to the third feature amount calculation area 60 including the first measurement point 22 located in the measurement area 20 that is an area that is different from the evaluation area 10 and includes the second transmission point 21, and a fourth feature amount related to the fourth feature amount calculation area 60 including the second measurement point 22 located in the measurement area 20; and the actual measurement/correction unit 130 that calculates a relative value of the first estimation value and the second estimation value, actually measures and corrects the first estimation value on the basis of the first to fourth feature amounts and the calculated relative value, and calculates a correction value of the first estimation value.

Hereinafter, the function units of the radio wave propagation property calculation device 100 will be described in more detail. The topography/object data storage unit 140 stores information related to buildings and topography included in the evaluation area 10 and the measurement area 20 in advance. A specific example of the information related to the buildings and the topography includes map data or altitude data.

The propagation data storage unit 150 stores position information and an antenna gain of the measurement point 22 in the measurement area 20, and measurement data or simulation data related to the propagation property in advance.

The propagation estimation unit 110 estimates the propagation property at the evaluation point 12 and the reference point 13 using the predetermined propagation estimation formula from the transmission point/evaluation point information, and the information related to the buildings and the topography stored in the topography/object data storage unit 140. Specific examples of the predetermined propagation estimation formula include an empirical formula of the Okumura-Hata model, the ITU-R P. 1546 model, or the like, a deterministic model that is based on electromagnetic analysis such as the geometric optics theory. Different propagation estimation formulae may be applied to the evaluation point 12 and the reference point 13. The transmission point/evaluation point information includes position information and antenna gains of the transmission point and the evaluation point. The deterministic model based on electromagnetic analysis such as the geometric optics theory is, for example, the ray-tracing method. The ray-tracing method is a method of approximately regarding a radio wave as a ray, expressing each of a plurality of propagation routes between a transmission point and a reception point of the radio wave as a propagation route including all or part of a direct wave, a reflected wave, and a diffracted wave, and estimating the propagation property of the radio wave.

The feature amount calculation unit 120 sets the feature amount calculation areas 50 from the evaluation point information, and sets the feature amount calculation areas 60 from the position information of the measurement point 22 stored in the propagation data storage unit 150.

Furthermore, the feature amount calculation unit 120 calculates a feature amount related to each of the feature amount calculation areas 50 and 60 from the transmission point/evaluation point information, the information related to the buildings and the topography stored in the topography/object data storage unit 140, and the information related to the measurement point stored in the propagation data storage unit 150. A specific example of a feature amount calculation method is a convolution operation related to heights of and positional relationships between buildings and topography in a feature amount calculation area.

The actual measurement/correction unit 130 calculates the degree of similarity between feature amount calculation areas from the estimation values of the propagation properties at the evaluation point 12 and the reference point 13 output from the propagation estimation unit 110, a measurement value of the propagation property at the measurement point 22 stored in the propagation data storage unit 150, and the feature amount of the feature amount calculation area output from the feature amount calculation unit 120, and corrects the estimation value of the propagation property at the evaluation point 12 using the calculated degree of similarity. A specific example of a similarity degree calculation method includes setting a higher degree of similarity as a correlation between feature amounts is higher, and setting the degree of similarity as a value equal to or more than zero and equal to or less than one. A specific example of a correction method is the following equation (1).

$${P}_{A}^{′} = {P}_{B} + ( {P}_{A} - {P}_{B} ) ( 1 - {α}_{A , C} {α}_{B , D} ) + ( {P}_{C} - {P}_{D} ) {α}_{A , C} {α}_{B , D} \qquad ( 1 )$$

The equation (1) is a formula for correcting the propagation property. In the equation (1), P_{A}′ represents a post-correction estimation value of a propagation property at the evaluation point 12, P_{A} represents a pre-correction estimation value of the propagation property at the evaluation point 12, P_{B} represents an estimation value of the propagation property at the reference point 13, P_{C} represents a measurement value of the propagation property at the measurement point 22 (hereinafter, referred to as a “measurement point 22a”) that has a high degree of similarity to that of the evaluation point 12, P_{D} represents a measurement value of the propagation property at the measurement point 22 (hereinafter, referred to as a “measurement point 22b”) that has a high degree of similarity to that of the reference point 13, α_{A, C} represents the degree of similarity (a first degree of similarity) of the feature amount calculation area 50 that surrounds the evaluation point 12 and the feature amount calculation area 60 that surrounds the measurement point 22a, and α_{B, D} represents the degree of similarity (a second degree of similarity) of the feature amount calculation area 50 that surrounds the reference point 13 and the feature amount calculation area 60 that surrounds the measurement point 22b. Note that each of the measurement point 22a and the measurement point 22b may include a plurality of measurement points, and, in this case, P_{C}, P_{D}, α_{A, C}, and α_{B, D} represent average values or median values. Furthermore, in the equation (1), (P_{A}−P_{B}) expresses a relative estimation value of the evaluation point 12 for which the estimation value at the reference point 13 serves as a reference, and (P_{C}−P_{D}) expresses a relative measurement value of the measurement point 22a for which the measurement value at the measurement point 22b serves as a reference. Note that, in a case where there are a plurality of the reference points 13, P_{A}′ may be calculated on the basis of the equation (1) for each reference point, and an average value or a median value of a plurality of calculated P_{A}′ may be the post-correction estimation value of the propagation property at the evaluation point 12.

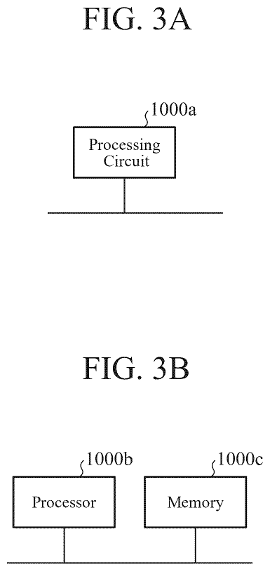

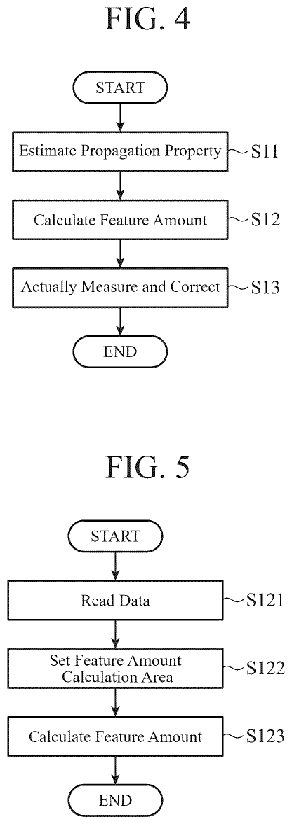

Next, a hardware configuration example of the radio wave propagation property calculation device 100 will be described with reference to FIGS. 3A and 3B. The functions of the radio wave propagation property calculation device 100 are implemented by a processing circuitry. The processing circuitry may be a dedicated processing circuit 1000a illustrated in FIG. 3A, or may be a processor 1000b that executes programs stored in a memory 1000c illustrated in FIG. 4B.

In a case where the processing circuitry is the dedicated processing circuit 1000a, the dedicated processing circuit 1000a corresponds to, for example, a single circuit, a composite circuit, a programmed processor, a parallel-programmed processor, an Application Specific Integrated Circuit (ASIC), a Field-Programmable Gate Array (FPGA), or a combination thereof. Each function unit of the radio wave propagation property calculation device 100 may be implemented by a plurality of different processing circuits, or the functions units may be collectively implemented by a single processing circuit.

In a case where the processing circuitry is the processor 1000b, the functions of the radio wave propagation property calculation device 100 may be implemented as software, firmware, or a combination of software and firmware. The software and the firmware are described as programs, and stored in the memory 1000c. The processor 1000b implements the function units of the radio wave propagation property calculation device 100 by reading and executing the programs stored in the memory. Here, examples of the memory 1000c include a non-volatile or volatile semiconductor memory such as a Random Access Memory (RAM), a Read-Only Memory (ROM), a flash memory, an Erasable Programmable Read Only Memory (EPROM), or an Electrically Erasable programmable Read-Only Memory (EEPROM), a magnetic disk, a flexible disk, an optical disk, a compact disk, a mini disk, and a DVD.

Note that part of the function units of the radio wave propagation property calculation device 100 may be implemented as dedicated hardware, and part of the rest of function units may be implemented as software or firmware. Thus, the processing circuitry can implement the above-described function units as hardware, software, firmware, or a combination thereof.

### <Operation of Radio Wave Propagation Property Calculation Device 100>

Next, an operation of the radio wave propagation property calculation device 100 according to Embodiment 1 will be described with reference FIGS. 4 to 6. FIG. 4 is a flowchart illustrating an operation example of the radio wave propagation property calculation device 100.

### (Step S11: Estimation of Propagation Property)

In step S11, the propagation estimation unit 110 reads the transmission point/evaluation point information, and the information stored in the topography/object data storage unit 140, and calculates an estimation value of a propagation property at an evaluation point on the basis of the predetermined propagation estimation formula. The propagation estimation unit 110 invokes the feature amount calculation unit 120.

### (Step S12: Calculation of Feature Amount)

In step S12, the feature amount calculation unit 120 reads the transmission point/evaluation point information, the information stored in the topography/object data storage unit 140, and the information stored in the propagation data storage unit 150, sets the feature amount calculation areas 50 and 60, and calculates the feature amount of each feature amount calculation area. The feature amount calculation unit 120 invokes the actual measurement/correction unit 130.

### (Step S13: Actual Measurement and Correction)

In step S13, the actual measurement/correction unit 130 reads the transmission point/evaluation point information, the estimation value of the propagation property at the evaluation point estimated by the propagation estimation unit 110, the feature amount of each feature amount calculation area calculated by the feature amount calculation unit 120, and the information stored in the propagation data storage unit 150, calculates the degree of similarity between the feature amount calculation areas from a correlation between the feature amounts, extracts the measurement point 22a that has a high degree of similarity to that of the evaluation point 12 and the measurement point 22b that has a high degree of similarity to that of the reference point 13, and corrects the estimation value of the propagation property at the evaluation point 12 on the basis of the equation (1). Note that each of the measurement point 22a and the measurement point 22b may include a plurality of measurement points. Note that, in a case where there are a plurality of the evaluation points 12, each of S11 to S13 is applied to each evaluation point.

### <Operation of Feature Amount Calculation Unit 120>

Next, an operation of the feature amount calculation unit 120 according to Embodiment 1 will be described with reference FIG. 5. FIG. 5 is a flowchart illustrating an operation example of the feature amount calculation unit 120.

### (Step S121: Reading of Data)

In step S121, the transmission point/evaluation point information, the information stored in the topography/object data storage unit 140, and the information stored in the propagation data storage unit 150 are read.

### (Step S122: Setting of Feature Amount Calculation Area)

In step S122, the feature amount calculation area 50 that surrounds each evaluation point and has a square shape having sides of predetermined lengths or a circle having a predetermined radius is set. Similarly, the feature amount calculation area 60 that surrounds each measurement point and has a square shape having sides of predetermined lengths or a circle having a predetermined radius is set. Note that the shapes of the feature amount calculation areas 50 and 60 are the same.

### (Step S123: Calculation of Feature Amount)

In step S123, each of the feature amount calculation areas 50 and 60 is divided into a grid pattern, and the feature amount of each of the feature amount calculation areas 50 and 60 is calculated on the basis of an average value of sums of building heights and elevations in each grid, and a distance from the center point of each grid to the transmission point. Note that a method of dividing the feature amount calculation areas 50 and 60 is the same. Furthermore, the feature amount may be a single numerical value, or may be a matrix that can be expressed by a plurality of numerical values. Furthermore, a specific example of a feature amount calculation method is a convolution operation. Furthermore, in addition to an average value of sums of building heights and elevations in each grid, and a distance from the center point of each grid to the transmission point, a distance from the center point of each grid to an evaluation point or a measurement point may be used. Furthermore, a feature amount may be calculated on the basis of a maximum value or a minimum value of the sum of the building heights and the elevations in each grid.

### <Operation of Actual Measurement/Correction Unit 130>

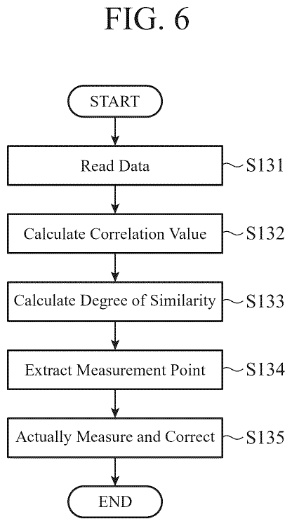

Next, an operation of the actual measurement/correction unit 130 according to Embodiment 1 will be described with reference FIG. 6. FIG. 6 is a flowchart illustrating an operation example of the actual measurement/correction unit 130.

### (Step S131: Reading of Data)

In step S131, the transmission point/evaluation point information, the estimation value of the propagation property at the evaluation point estimated by the propagation estimation unit 110, the feature amount calculated by the feature amount calculation unit 120, and the information stored in the propagation data storage unit 150 are read.

### (Step S132: Calculation of Correlation Value)

A correlation value is calculated for any set of the feature amount calculation area 50 and the feature amount calculation area 60 on the basis of the calculated feature amount. Note that, in a case where the feature amount is a single numerical value, for example, a reciprocal of a difference between a pair of feature amounts is a correlation value, and, in a case where a feature amount is a matrix that can be expressed by a plurality of numerical values, a correlation value is calculated on the basis of, for example, the equation (2). In the equation (2), C represents a correlation value of a numerical sequence x and a numerical sequence y, s_{xy} represents a covariance of the numerical sequence x and the numerical sequence y, σₓ represents a standard deviation of the numerical sequence x, and σ_{y} represents a standard deviation of the numerical sequence y.

$$C = \frac{{S}_{x y}}{{σ}_{x} {σ}_{y}} \qquad ( 2 )$$

### (Step S133: Calculation of Degree of Similarity)

The degree of similarity is calculated for any set of the feature amount calculation area 50 and the feature amount calculation area 60 on the basis of the calculated correlation value. Note that the degree of similarity is set to a value equal to or more than zero and equal to or less than one. A specific example of a similarity degree calculation method is a function expressed by the equation (3). In the equation (3), x represents a correlation value.

$$f ( x ) = \frac{1}{1 + {e}^{- x}} \qquad ( 3 )$$

### (Step S134: Extraction of Measurement Point)

The measurement point 22a whose degree of similarity to the evaluation point 12 is higher than a predetermined threshold is extracted on the basis of the calculated degree of similarity. The measurement point 22b whose degree of similarity to the reference point 13 is higher than the predetermined threshold is extracted likewise. The threshold is set in such a way that at least the one measurement point 22a and the one measurement point 22b are extracted.

### (Step S135: Actual Measurement and Correction)

When a plurality of the measurement points 22a or the measurement points 22b are extracted, an average value or a median value of the respective measurement values is calculated, and an estimation value of the propagation property at the evaluation point 12 is corrected on the basis of the equation (1).

### Explanation of Effect

The actual measurement/correction unit 130 can calculate the degree of similarity for any set of an evaluation point and a measurement point (or any set of the feature amount calculation area 50 and the feature amount calculation area 60) on the basis of a feature amount independently calculated for each evaluation point and each measurement point by the feature amount calculation unit 120.

The actual measurement/correction unit 130 can correct the estimation value of the propagation property of the evaluation point 12 using measurement data of a measurement point having a high degree of similarity on the basis of the calculated degree of similarity. Furthermore, the actual measurement/correction unit 130 corrects the estimation value of the evaluation point 12 on the basis of the relative value of the estimation value and the measurement value of the propagation property, so that, even when transmission electric power or average antenna gains of the transmission point 11 in the evaluation area 10 and the transmission point 21 in the measurement area 20 is different, it is also possible to actually measure and correct the evaluation value without an influence of the transmission electric power or the average antenna gains.

According to the above operation, the radio wave propagation property calculation device 100 according to Embodiment 1 can correct the estimation value even when a measurement point is not in the evaluation area 10 and is in the other measurement area 20, and calculate an accurate estimation value.

### Embodiment 2

Embodiment 1 has described the case where the reference point 13 has been determined as an evaluation point different from the correction target evaluation point 12. Embodiment 2 will describe a case where the reference point 13 is an evaluation point different from the correction target evaluation point 12, and the reference point 13 is determined on the basis of the degree of reliability of the estimation value.

The present embodiment differs from Embodiment 1 in a reference point determination method. The present embodiment will mainly describe these differences, and description of similar aspects to those of Embodiment 1 will be omitted.

### <Configuration of Radio Wave Propagation Property Calculation Device 200>

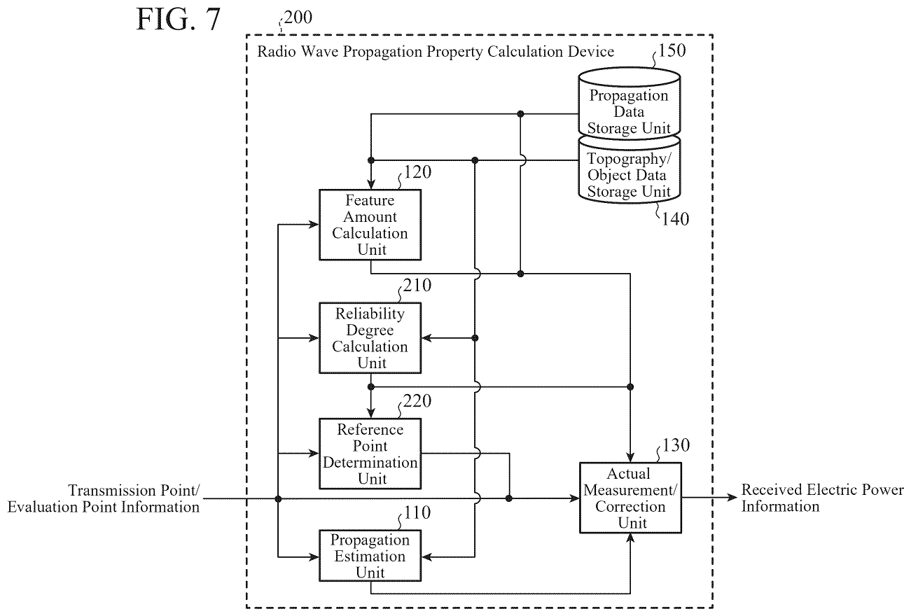

A configuration of a radio wave propagation property calculation device 200 will be described with reference FIG. 7. FIG. 7 is a block diagram illustrating the configuration example of the radio wave propagation property calculation device 200 according to the present embodiment. The radio wave propagation property calculation device 200 receives input of information related to a transmission point and an evaluation point, and outputs received electric power information obtained at the evaluation point 12. The radio wave propagation property calculation device 200 according to one aspect includes the propagation estimation unit 110, the feature amount calculation unit 120, the actual measurement/correction unit 130, the topography/object data storage unit 140, the propagation data storage unit 150, a reliability degree calculation unit 210, and a reference point determination unit 220 as components or function units. The topography/object data storage unit 140 and the propagation data storage unit 150 may be provided outside the radio wave propagation property calculation device 200.

Furthermore, compared to the radio wave propagation property calculation device 100 according to Embodiment 1, the radio wave propagation property calculation device 200 according to one aspect further includes the reliability degree calculation unit 210 that calculates the degree of reliability from a distance between the first transmission point and each target point, and the number of shielding objects on a line segment connecting the first transmission point and each target point.

Furthermore, compared to the radio wave propagation property calculation device 100 according to Embodiment 1, the radio wave propagation property calculation device 200 according to one aspect further includes the reference point determination unit 220 that determines the first reference point from a plurality of target points on the basis of the degree of reliability indicating reliability of a received electric power estimation value at each of the target points, and the reference point determination unit 220 determines as the first reference point a target point having the degree of reliability equal to or higher than the degree of reliability at the first evaluation point.

Hereinafter, the function units of the radio wave propagation property calculation device 200 will be described in more detail. The reliability degree calculation unit 210 calculates the degree of reliability on the basis of the transmission point/evaluation point information, the information related to the buildings and the topography stored in the topography/object data storage unit 140, and the number of the shielding objects 30 located on a line segment whose end points are the transmission point and each evaluation point.

The reference point determination unit 220 determines a reference point on the basis of the evaluation point information and the degree of reliability output from the reliability degree calculation unit 210.

### <Operation of Radio Wave Propagation Property Calculation Device 200>

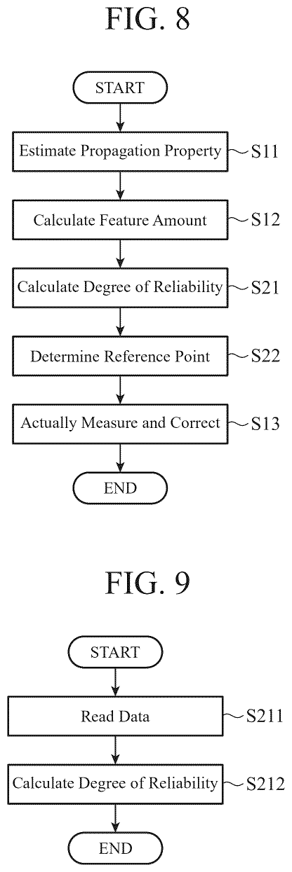

Next, an operation of the radio wave propagation property calculation device 200 according to Embodiment 2 will be described with reference FIG. 8. FIG. 8 is a flowchart illustrating an operation example of the radio wave propagation property calculation device 200.

### (Step S12: Calculation of Feature Amount)

In step S12, the feature amount calculation unit 120 reads the transmission point/evaluation point information, the information stored in the topography/object data storage unit 140, and the information stored in the propagation data storage unit 150, sets the feature amount calculation areas 50 and 60, and calculates the feature amount of each feature amount calculation area. The feature amount calculation unit 120 invokes the reliability degree calculation unit 210.

### (Step S21: Calculation of Degree of Similarity)

In step S21, the reliability degree calculation unit 210 reads the transmission point/evaluation point information, and the information related to the buildings and the topography stored in the topography/object data storage unit 140, and calculates the degree of reliability of each evaluation point on the basis of a distance from a transmission point to each evaluation point, and the number of the shielding objects 30 located on a line segment whose end points are the transmission point and each evaluation point. Note that the distance may be a three-dimensional distance, or may be a two-dimensional distance projected on a horizontal plane. The reliability degree calculation unit 210 invokes the reference point determination unit 220.

### (Step S22: Determination of Reference Point)

In step S22, the reference point determination unit 220 determines a reference point on the basis of the evaluation point information and the degree of reliability output from the reliability degree calculation unit 210. The reference point determination unit 220 invokes the actual measurement/correction unit 130.

### <Operation of Reliability Degree Calculation Unit 210>

Next, an operation of the reliability degree calculation unit 210 according to Embodiment 2 will be described with reference FIG. 9. FIG. 9 is a flowchart illustrating an operation example of the reliability degree calculation unit 210.

### (Step S211: Reading of Data)

The transmission point/evaluation point information, and the information related to the buildings and the topography stored in the topography/object data storage unit 140 are read.

### (Step S212: Calculation of Degree of Similarity)

A distance from a transmission point to each evaluation point is calculated, the number of the shielding objects 30 located on a line segment whose end points are the transmission point and each evaluation point is calculated, and a value of a reciprocal of a product of the distance and the number of the shielding objects 30 is determined as the degree of reliability.

### <Operation of Reference Point Determination Unit 220>

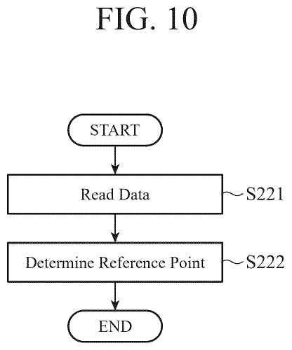

Next, an operation of the reference point determination unit 220 according to Embodiment 2 will be described with reference FIG. 10. FIG. 10 is a flowchart illustrating an operation example of the reference point determination unit 220.

### (Step S221: Reading of Data)

The evaluation point information and the degree of reliability calculated by the reliability degree calculation unit 210 are read.

### (Step S222: Determination of Reference Point)

Other evaluation points having the degree of reliability equal to or more than the degree of reliability at the correction target evaluation point 12 are extracted, and an evaluation point whose product of a reciprocal of the distance to the evaluation point 12 and the degree of reliability is the largest among extracted evaluation points is determined as the reference point. Note that the distance may be a three-dimensional distance, or may be a two-dimensional distance projected on a horizontal plane. When there is no other evaluation point having a higher degree of reliability than that of the correction target evaluation point 12, the correction target evaluation point 12 is determined as the reference point.

### Explanation of Effect

An additional effect according to Embodiment 2 will be described.

The reliability degree calculation unit 210 according to Embodiment 2 can calculate a high degree of reliability as a distance between a transmission point and an evaluation point is shorter or as the number of shielding objects located on a line segment whose end points are the transmission point and the evaluation point is smaller. Particularly, as the number of shielding objects is smaller, a propagation route of a radio wave becomes more simple, so that it is possible to improve estimation accuracy of the predetermined propagation estimation formula.

The reference point determination unit 220 according to Embodiment 2 can determine as the reference point 13 an evaluation point having the degree of reliability equal to or more than the degree of reliability at the evaluation point 12 at all times.

The actual measurement/correction unit 130 according to Embodiment 2 can correct the estimation value of the propagation property as a relative value for which the reference point 13 determined by the reference point determination unit 220 serves as the reference.

According to the above operation, the radio wave propagation property calculation device 200 according Embodiment 2 can calculate a more accurate estimation value than that of the radio wave propagation property calculation device 100 according to Embodiment 1.

### Embodiment 3

Embodiments 1 and 2 have described the cases where the evaluation point 12 and the reference point 13 are located in the different feature amount calculation areas 50. Embodiment 3 will describe a case where the evaluation point 12 and the reference point 13 are located in the same feature amount calculation area. That is, according to one aspect of the present embodiment, the first feature amount calculation area and the second feature amount calculation area are an identical fifth feature amount calculation area, the third feature amount calculation area and the fourth feature amount calculation area are an identical sixth feature amount calculation area, the feature amount calculation unit calculates a fifth feature amount related to the fifth feature amount calculation area instead of the first feature amount and the second feature amount, and calculates a sixth feature amount related to the sixth feature amount calculation area instead of the third feature amount and the fourth feature amount, and the actual measurement/correction unit performs the calculation using the fifth feature amount and the sixth feature amount instead of the first to fourth feature amounts.

The present embodiment differs from Embodiments 1 and 2 in an explanatory view of the evaluation area 10 and the measurement area 20, an operation of the actual measurement/correction unit, and a correction formula of the propagation property. The present embodiment will mainly describe these differences, and description of similar aspects to those of Embodiments 1 and 2 will be omitted.

### <Explanation of Evaluation Area 10 and Measurement Area 20>

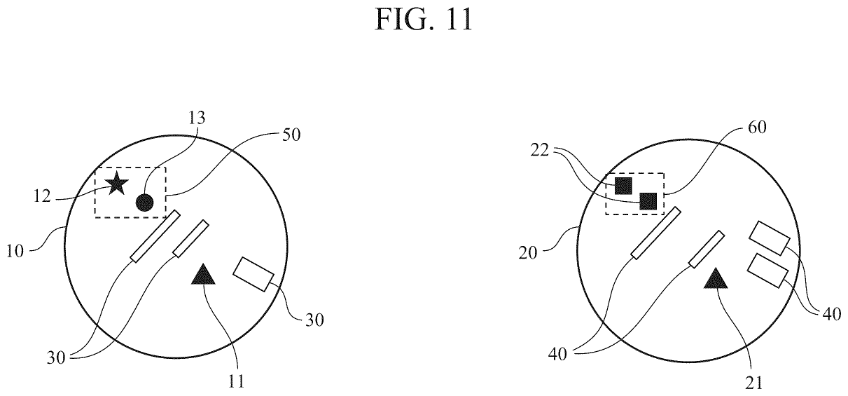

FIG. 11 is an explanatory view of the evaluation area 10 and the measurement area 20 according to the present embodiment. As illustrated in FIG. 11, the evaluation point 12 and the reference point 13 are located in the same feature amount calculation area 50, and the plurality of measurement points 22 are located in the same feature amount calculation area 60.

### <Operation of Actual Measurement/Correction Unit 130>

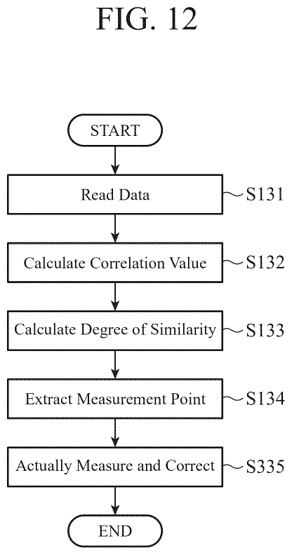

Next, an operation of the actual measurement/correction unit 130 according to Embodiment 3 will be described with reference FIG. 12. FIG. 12 is a flowchart illustrating an operation example of the actual measurement/correction unit 130. The present embodiment differs from Embodiments 1 and 2 in contents of step S135 (actual measurement and correction) in the flowchart indicating the operation example of the actual measurement/correction unit 130 illustrated in FIG. 6. The present embodiment will mainly describe these differences, and description of the identical aspects will be omitted.

### (Step S335: Actual Measurement and Correction)

When the plurality of measurement points 22a or measurement points 22b are extracted in step S335, the actual measurement/correction unit 130 calculates an average value or a median value of the respective measurement values, and corrects an estimation value of the propagation property at the evaluation point 12 on the basis of the following equation (4).

$${P}_{A}^{′} = {P}_{B} + ( {P}_{A} - {P}_{B} ) ( 1 - {α}_{A , C} ) + ( {P}_{C} - {P}_{D} ) {α}_{A , C} \qquad ( 4 )$$

The equation (4) is a formula for correcting the propagation property in the present embodiment. In the equation (4), P_{A}′ represents a post-correction estimation value of a propagation property at the evaluation point 12, P_{A} represents a pre-correction estimation value of the propagation property at the evaluation point 12, P_{B} represents an estimation value of the propagation property at the reference point 13, P_{C} represents a measurement value of the propagation property at the measurement point 22 (i.e., measurement point 22a) that has a high degree of similarity to that of the evaluation point 12, P_{D} represents a measurement value of the propagation property at the measurement point 22 (i.e., measurement point 22b) that has a high degree of similarity to that of the reference point 13, and α_{A, C} represents the degree of similarity of the feature amount calculation area 50 that surrounds the evaluation point 12 and the reference point 13 and the feature amount calculation area 60 that surrounds the measurement points 22a and 22b.

### Explanation of Effect

An additional effect according to Embodiment 3 will be described.

The evaluation point 12 and the reference point 13 are located in the same feature amount calculation area, so that the feature amount calculation unit 120 according to Embodiment 3 can calculate a feature amount including the positional relationship between the evaluation point 12 and the reference point 13.

The actual measurement/correction unit 130 according to Embodiment 3 can calculate the degree of similarity on the basis of the feature amount including the positional relationship between the evaluation point 12 and the reference point 13, and correct the estimation value of the propagation property of the evaluation point 12.

According to the above operation, the radio wave propagation property calculation device 100 or the radio wave propagation property calculation device 200 according Embodiment 3 can calculate a more accurate estimation value than that of the radio wave propagation property calculation device 100 according to Embodiment 1 or the radio wave propagation property calculation device 200 according to Embodiment 2.

### Embodiment 4

Embodiments 1, 2, and 3 have described the cases where the feature amount related to each of the feature amount calculation areas 50 and 60 is calculated from the transmission point/evaluation point information, the information related to the buildings and the topography stored in the topography/object data storage unit, and the information related to the measurement point stored in the propagation data storage unit. Embodiment 4 will describe a case where a feature amount is calculated on the basis of an estimation value of a propagation property and outlook information in addition to the above information.

The present embodiment differs from Embodiments 1, 2, and 3 in a feature amount calculation method. That is, according to a radio wave propagation property calculation device 400 according to Embodiment 4, the feature amount calculation unit calculates each feature amount on the basis of outlook information indicating whether or not a shielding object exists on a line segment whose end points are the first transmission point or the second transmission point, and a point of interest in each feature amount calculation area. The present embodiment will mainly describe these differences, and description of similar aspects to those of Embodiments 1, 2, and 3 will be omitted.

### <Configuration of Radio Wave Propagation Property Calculation Device 400>

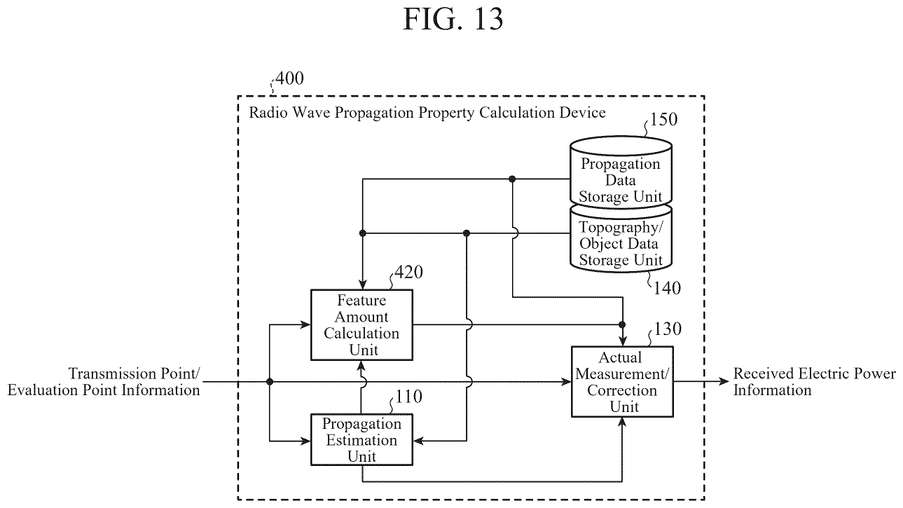

FIG. 13 is a block diagram illustrating the configuration example of the radio wave propagation property calculation device 400 according to the present embodiment. The radio wave propagation property calculation device 400 receives input of information related to a transmission point and an evaluation point, and outputs received electric power information obtained at the evaluation point 12. The radio wave propagation property calculation device 400 according to one aspect includes the propagation estimation unit 110, a feature amount calculation unit 420, the actual measurement/correction unit 130, the topography/object data storage unit 140, and the propagation data storage unit 150 as components or function units. The topography/object data storage unit 140 and the propagation data storage unit 150 may be provided outside the radio wave propagation property calculation device 400.

The feature amount calculation unit 420 sets the feature amount calculation area 50 from the evaluation point information, and sets the feature amount calculation area 60 from the position information of the measurement point 22 stored in the propagation data storage unit 150.

The feature amount calculation unit 420 calculates outlook information on insides of the feature amount calculation area 50 and the feature amount calculation area 60 from information related to the transmission point, and the information related to the buildings and the topography stored in the topography/object data storage unit 140. In the present disclosure, the outlook information means information indicating whether or not a shielding object exists on a line segment whose end points are the transmission point and the point of interest.

The feature amount calculation unit 420 calculates a feature amount related to each of the feature amount calculation areas 50 and 60 from the transmission point/evaluation point information, the estimation value of the propagation property estimated by the propagation estimation unit 110, the information related to the buildings and the topography stored in the topography/object data storage unit 140, the information related to the measurement point stored in the propagation data storage unit 150, and the outlook information. A specific example of the feature amount calculation method is a convolution operation related to heights of and positional relationships between the buildings and the topography in the feature amount calculation area, the estimation value of the propagation property, and the outlook information.

### <Operation of Radio Wave Propagation Property Calculation Device 400>

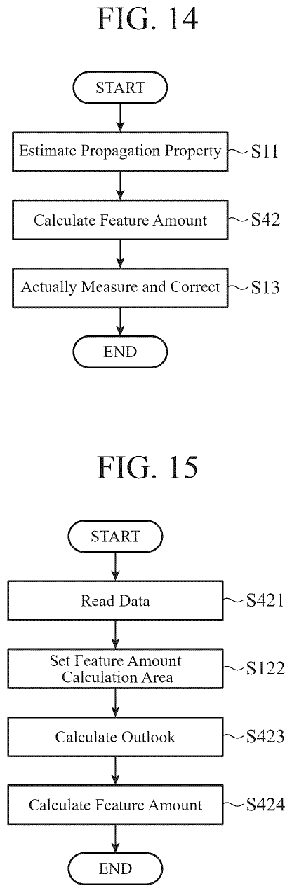

FIG. 14 is a flowchart illustrating an operation example of the radio wave propagation property calculation device 400 according to the present embodiment. The present embodiment differs from Embodiments 1, 2, and 3 in contents of step S12 (calculation of the feature amount) in the flowchart indicating the operation example of the radio wave propagation property calculation device 100 illustrated in FIG. 4.

### (Step S42: Calculation of Feature Amount)

In step S42, the feature amount calculation unit 120 reads the transmission point/evaluation point information, the estimation value of the propagation property estimated by the propagation estimation unit 110, the information stored in the topography/object data storage unit 140, and the information stored in the propagation data storage unit 150, sets the feature amount calculation areas 50 and 60, and calculates the outlook information on the inside of each feature amount calculation area, and calculates the feature amount of each feature amount calculation area. The feature amount calculation unit 120 invokes the actual measurement/correction unit 130.

### <Operation of Feature Amount Calculation Unit 420>

FIG. 15 is a flowchart illustrating an operation example of the feature amount calculation unit 420. Next, an operation of the feature amount calculation unit 420 according to Embodiment 4 will be described with reference FIG. 15.

### (Step S421: Reading of Data)

In step S421, the transmission point/evaluation point information, the information stored in the topography/object data storage unit 140, the information stored in the propagation data storage unit 150, and the estimation value of the propagation property estimated by the propagation estimation unit 110 are read.

### (Step S122: Setting of Feature Amount Calculation Area)

In step S122, the feature amount calculation area 50 that surrounds each evaluation point and has a square shape having sides of predetermined lengths or a circle having a predetermined radius is set. Similarly, the feature amount calculation area 60 that surrounds each measurement point and has a square shape having sides of predetermined lengths or a circle having a predetermined radius is set. Note that the shapes of the feature amount calculation areas 50 and 60 are the same.

### (Step S423: Calculation of Outlook)

In step S423, each of the feature amount calculation areas 50 and 60 is divided into a grid pattern, and whether or not there is a shielding object on a line segment whose end points are a center point of each grid and a transmission point, and it is determined that there is no outlook when there is the shielding object, and it is determined that there is an outlook when there is no shielding object. A specific example of a distinguishing method is to allocate 1 when there is no outlook, and allocate 0 when there is the outlook.

### (Step S424: Calculation of Feature Amount)

On the basis of the average value of sums of building heights and elevations in each grid, a distance from the center point of each grid to the transmission point, the estimation value of the propagation property at the evaluation point 12 in each grid or the measurement value at the measurement point 22 stored in the propagation data storage unit, and the outlook information at the center point in each grid, the feature amount of each of the feature amount calculation areas 50 and 60 is calculated. Note that a method of dividing the feature amount calculation areas 50 and 60 is the same. Furthermore, the feature amount may be a single numerical value, or may be a matrix that can be expressed by a plurality of numerical values. Furthermore, a specific example of a feature amount calculation method is a convolution operation. Furthermore, in addition to an average value of sums of building heights and elevations in each grid, and a distance from the center point of each grid to the transmission point, a distance from the center point of each grid to an evaluation point or a measurement point may be used. Furthermore, a feature amount may be calculated on the basis of a maximum value or a minimum value of the sum of the building heights and the elevations in each grid.

### Explanation of Effect

An additional effect according to Embodiment 4 will be described.

The feature amount calculation unit 420 according to Embodiment 4 can calculate an estimation value or a measurement value of propagation loss in a feature amount calculation area, and a feature amount including outlook information.

Even when the heights of or the positional relationships between the buildings and the topography are similar in the feature amount calculation area 50 or 60, but when, for example, the heights of a building and topography near a transmission point outside the feature amount calculation area are greatly different, the outlook information on the inside of the feature amount calculation area or the estimation value or the measurement value of the propagation loss is not necessarily be similar. Conversely, by calculating a feature amount including the outlook information or the estimation value or the measurement value of the propagation loss, it is possible to reflect not only a situation in the feature amount calculation area, but also a situation outside the feature amount calculation area.

According to the above operation, the radio wave propagation property calculation device 400 according to Embodiment 4 can calculate a more accurate estimation value than that of the radio wave propagation property calculation device 100 according to Embodiment 1.

### Embodiment 5

Embodiments 1, 2, 3, and 4 have described the cases where the estimation value of the propagation property is corrected by the equation (1) or the equation (4). Embodiment 5 will describe a case where a feature amount is calculated by a regression model constructed by machine learning, and an estimation value of a propagation property is calculated.

The present embodiment differs from Embodiments 1, 2, 3, and 4 in a block diagram of a radio wave propagation property calculation device, a feature amount calculation method, and a method of correcting an estimation value of a propagation property. The present embodiment will mainly describe these differences, and description of similar aspects to those of Embodiments 1, 2, 3, and 4 will be omitted.

### <Inference Phase>

### <Configuration of Radio Wave Propagation Property Calculation Device 500>

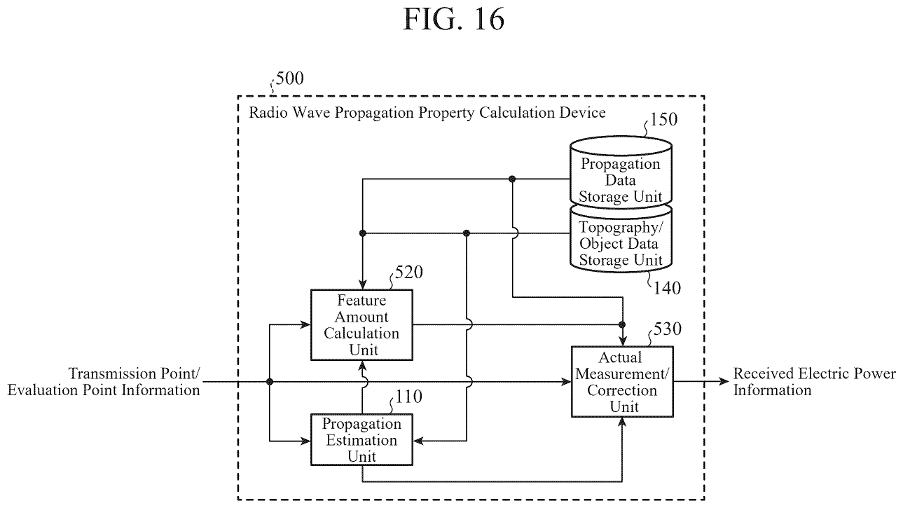

FIG. 16 is a block diagram illustrating the configuration example of a radio wave propagation property calculation device 500 according to the present embodiment. The radio wave propagation property calculation device 500 receives input of information related to a transmission point and an evaluation point, and outputs received electric power information obtained at the evaluation point 12. The radio wave propagation property calculation device 500 according to one aspect includes the propagation estimation unit 110, a feature amount calculation unit 520, an actual measurement/correction unit 530, the topography/object data storage unit 140, and the propagation data storage unit 150 as components or function units. The topography/object data storage unit 140 and the propagation data storage unit 150 may be provided outside the radio wave propagation property calculation device 500.

The feature amount calculation unit 520 sets the feature amount calculation area 50 from the evaluation point information, and sets the feature amount calculation area 60 from the position information of the measurement point 22 stored in the propagation data storage unit 150.

Furthermore, the feature amount calculation unit 520 calculates outlook information on the insides of the feature amount calculation area 50 and the feature amount calculation area 60 from information related to the transmission point, and the information related to the buildings and the topography stored in the topography/object data storage unit 140.

The feature amount calculation unit 520 calculates a feature amount related to each of the feature amount calculation areas 50 and 60 from the transmission point/evaluation point information, the estimation value of the propagation property estimated by the propagation estimation unit 110, the information related to the buildings and the topography stored in the topography/object data storage unit 140, the information related to the measurement point stored in the propagation data storage unit 150, and the outlook information. A specific example of the feature amount calculation method is a convolutional neural network that receives input of heights of and positional relationships between the buildings and the topography in the feature amount calculation area, the estimation value of the propagation property, and the outlook information. The convolutional neural network is held in the feature amount calculation unit 520 or an unillustrated storage unit.

The actual measurement/correction unit 530 calculates an estimation value of a propagation property at the evaluation point 12 by a deconvolutional neural network from the transmission point/evaluation point information and the feature amount calculated by the feature amount calculation unit 520. The deconvolutional neural network is held in the actual measurement/correction unit 530 or the unillustrated storage unit.

### <Operation of Feature Amount Calculation Unit 520>

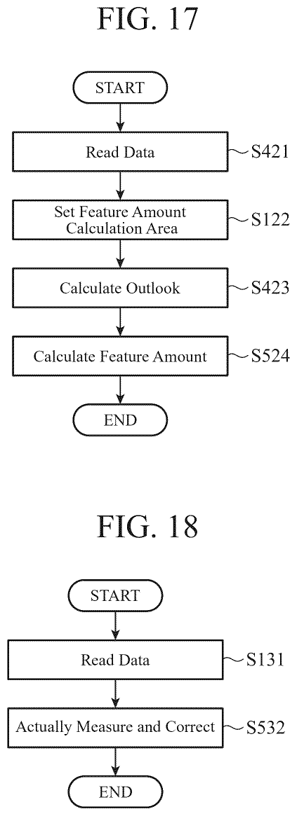

FIG. 17 is a flowchart illustrating an operation example of the feature amount calculation unit 520. The present embodiment differs from Embodiment 4 in contents of step S424 (calculation of the feature amount) in the processing of the feature amount calculation unit 420 in FIG. 15. The present embodiment will mainly describe these differences, and description related to the identical steps will be omitted.

### (Step S524: Calculation of Feature Amount)

On the basis of the average value of sums of building heights and elevations in each grid, a distance from the center point of each grid to the transmission point, the estimation value of the propagation property at the evaluation point 12 and the reference point 13 in each grid, and the outlook information at the center point in each grid, the feature amount of each of the feature amount calculation areas 50 and 60 is calculated. Note that a method of dividing the feature amount calculation areas 50 and 60 is the same. Furthermore, the estimation value of the propagation property at the evaluation point is a relative value for which the reference point 13 serves as a reference. Furthermore, as a specific example of calculation of a feature amount, the convolutional neural network is used. The convolutional neural network may include a plurality of convolutional layers and a plurality of pooling layers. Furthermore, only an output from a last layer of the convolutional neural network may be a feature amount, and an output from an intermediate layer may be also included in a feature amount.

### <Operation of Actual Measurement/Correction Unit 530>

FIG. 18 is a flowchart illustrating an operation example of the actual measurement/correction unit 530. Next, an operation of the actual measurement/correction unit 530 according to Embodiment 5 will be described with reference FIG. 18.

### (Step S131: Reading of Data)

In step S131, the transmission point/evaluation point information and the feature amount calculated by the feature amount calculation unit 520 are read.

### (Step S532: Actual Measurement and Correction>

An estimation value of a propagation property at the evaluation point 12 is corrected on the basis of the calculated feature amount by the deconvolutional neural network as a relative value for which the reference point 13 serves as the reference, and an absolute value of the propagation property of the evaluation point 12 is calculated using the estimation value of the propagation property of the reference point 13.

### <Training Phase>

Although an embodiment of the training phase is not basically different from that of the inference phase, the convolutional neural network held in the feature extraction unit or the unillustrated storage unit and the deconvolutional neural network held in the actual measurement/correction unit or the unillustrated storage unit are trained in such a way that an output from the radio wave propagation property calculation device and a measurement value or a simulation value of propagation data stored in a propagation data storage unit match in a case of the training phase.

### Explanation of Effect

An additional effect according to Embodiment 5 will be described.

The actual measurement/correction unit 530 according to Embodiment 5 can correct the estimation value of the propagation property at the evaluation point 12 by a neural network trained in advance. The property of the neural network makes it possible to express every correction formula that is not limited to the equation (1) or the equation (4).

According to the above operation, the radio wave propagation property calculation device 500 according to Embodiment 5 can calculate a more accurate estimation value than that of the radio wave propagation property calculation device 100 according to Embodiment 1.

Note that the embodiments can be combined, and each embodiment can be modified or omitted as appropriate.

### INDUSTRIAL APPLICABILITY

When there is no measurement point in an evaluation area in which an evaluation target evaluation point of a radio wave propagation property is located, the radio wave propagation property calculation technique according to the present disclosure can be used as a technique of estimating the radio wave propagation property of the evaluation point.

### REFERENCE SIGNS LIST

10: evaluation area, 11: transmission point (first transmission point), 12: evaluation point (first evaluation point), 13: reference point (first reference point), 20: measurement area, 21: transmission point (second transmission point), 22: measurement point (first measurement point and second measurement point), 22a: measurement point, 22b: measurement point, 30: shielding object, 40: shielding object, 50: feature amount calculation area (first feature amount calculation area and second feature amount calculation area), 60: feature amount calculation area (third feature amount calculation area and fourth feature amount calculation area), 100: radio wave propagation property calculation device, 110: propagation estimation unit, 120: feature amount calculation unit, 130: actual measurement/correction unit, 140: topography/object data storage unit, 150: propagation data storage unit, 200: radio wave propagation property calculation device, 210: reliability degree calculation unit, 220: reference point determination unit, 400: radio wave propagation property calculation device, 420: feature amount calculation unit, 500: radio wave propagation property calculation device, 520: feature amount calculation unit, 530: actual measurement/correction unit, 1000a: processing circuit, 1000b: processor, 1000c: memory

1. A radio wave propagation property calculation device comprising processing circuitry
to calculate, using a predetermined propagation estimation formula, a first estimation value of received electric power of a radio wave and a second estimation value of received electric power of the radio wave, the radio wave being transmitted from a first transmission point, the received electric power of the first estimation value being received at a first evaluation point located in an evaluation area including the first transmission point, and the received electric power of the second estimation value being received at a first reference point located in the evaluation area,
to calculate a first feature amount, a second feature amount, a third feature amount and a fourth feature amount, the first feature amount being related to a first feature amount calculation area including the first evaluation point, the second feature amount being related to a second feature amount calculation area including the first reference point, the third feature amount being related to a third feature amount calculation area including a first measurement point located in a measurement area that is an area different from the evaluation area and includes a second transmission point, and the fourth feature amount being related to a fourth feature amount calculation area including a second measurement point located in the measurement area, and
to perform calculation of a relative value of the first estimation value and the second estimation value, and a correction value of the first estimation value by performing actual-measurement-based correction of the first estimation value on a basis of the first to fourth feature amounts and the calculated relative value.

2. The radio wave propagation property calculation device according to claim 1, wherein the processing circuitry calculates each of the first to fourth feature amounts by performing a convolution operation on a height and a positional relationship of topography or an object located in each of the first to fourth feature amount calculation areas.

3. The radio wave propagation property calculation device according to claim 1, wherein the predetermined propagation estimation formula includes a mathematical formula of an Okumura-Hata model or a mathematical formula of an ITU-R P. 1546 model.

4. The radio wave propagation property calculation device according to claim 1, wherein the predetermined propagation estimation formula includes a mathematical formula of a ray-tracing method.

5. The radio wave propagation property calculation device according to claim 1, wherein the processing circuitry is further configured to determine the first reference point from a plurality of target points on a basis of a degree of reliability indicating reliability of a received electric power estimation value at each of the target points,
wherein the processing circuit determines, as the first reference point, a target point having a degree of reliability equal to or higher than a degree of reliability at the first evaluation point.

6. The radio wave propagation property calculation device according to claim 5, wherein the processing circuitry is further configured to calculate the degree of reliability from a distance between the first transmission point and each of the plurality of target points, and a number of shielding objects on a line segment connecting the first transmission point and each of the plurality of target points.

7. The radio wave propagation property calculation device according to claim 1, wherein
the first feature amount calculation area and the second feature amount calculation area are an identical fifth feature amount calculation area,
the third feature amount calculation area and the fourth feature amount calculation area are an identical sixth feature amount calculation area,
the processing circuitry calculates a fifth feature amount related to the fifth feature amount calculation area instead of the first feature amount and the second feature amount, and calculates a sixth feature amount related to the sixth feature amount calculation area instead of the third feature amount and the fourth feature amount, and
the processing circuitry performs the calculation using the fifth feature amount and the sixth feature amount instead of the first to fourth feature amounts.

8. The radio wave propagation property calculation device according to claim 1, wherein the processing circuitry calculates each of the first to fourth feature amounts on a basis of outlook information indicating whether or not a shielding object exists on a line segment whose end points are the first transmission point or the second transmission point, and a point of interest in each of the first to fourth feature amount calculation areas.

9. The radio wave propagation property calculation device according to claim 8, wherein the processing circuitry calculates each of the first to fourth feature amounts by a convolutional neural network.

10. The radio wave propagation property calculation device according to claim 9, wherein the processing circuitry calculates an estimation value of a propagation property at an evaluation point by a deconvolutional neural network.

11. A radio wave propagation property calculation method performed by a radio wave propagation property calculation device including processing circuitry, the radio wave propagation property calculation method comprising:
calculating, using a predetermined propagation estimation formula, a first estimation value of received electric power of a radio wave and a second estimation value of received electric power of the radio wave, the radio wave being transmitted from a first transmission point, the received electric power of the first estimation value being received at a first evaluation point located in an evaluation area including the first transmission point, and the received electric power of the second estimation value being received at a first reference point located in the evaluation area;
calculating a first feature amount and a second feature amount, and a third feature amount and a fourth feature amount, the first feature amount being related to a first feature amount calculation area including the first evaluation point, the second feature amount being related to a second feature amount calculation area including the first reference point, the third feature amount being related to a third feature amount calculation area including a first measurement point located in a measurement area that is an area different from the evaluation area and includes a second transmission point, and the fourth feature amount being related to a fourth feature amount calculation area including a second measurement point located in the measurement area; and
performing calculation of a relative value of the first estimation value and the second estimation value, and a correction value of the first estimation value by performing actual-measurement-based correction of the first estimation value on a basis of the first to fourth feature amounts and the calculated relative value.
